(19) United States
(12) Patent Application Publication
(10) Pub. No.: US 2019/0311545 A1
(43) Pub. Date: Oct. 10, 2019

(54) Augmented Reality Advertising Systems and Methods

(71) Applicant: Michael J. Kintner, Olean, NY (US)

(72) Inventor: Michael J. Kintner, Olean, NY (US)

(21) Appl. No.: 16/379,530

(22) Filed: Apr. 9, 2019

Related U.S. Application Data
(60) Provisional application No. 62/761,866, filed on Apr. 10, 2018.

(51) Int. Cl. G06T 19/00; G06T 13/20; G06T 7/246; G06T 3/40; G06Q 30/02

(52) U.S. Cl. CPC G06T 19/006; G06T 13/20; G06Q 30/0241; G06T 3/40; G06T 7/251

(57) ABSTRACT

An augmented reality-based advertising system to overlay animated objects, such as animated images and/or video onto a product and/or product label. The advertising system may include an object database and a mobile device. In practice, a customer in a retail store uses their mobile device's camera to scan a product and/or product label. If the image from the scan matches an image found in the object database, the customer, on the screen on their mobile device, will see an animated object overlaid on the product and/or product label.

### BACKGROUND OF THE INVENTION

The present subject matter relates generally to augmented reality (AR). More specifically, the present invention relates to an advertising and marketing system that utilizes augmented reality to overlay animated objects on products and/or product labels.

In today's competitive retail landscape, corporations are always looking for ways to differentiate its products in the marketplace. One of the primary ways corporations do this is by investing heavily in advertisements and unique product and product label designs. Any unique feature of a product can create a “buzz” in the marketplace and will generally lead to increased sales and profits.

In recent years, corporations have begun using mobile-advertising and mobile-marketing to reach a broader group of customers, particularly younger generations who spend much of their time on mobile devices, such as smartphones and computer tablets. In fact, in or around 2016, mobile and tablet Internet usage exceeded desktop Internet usage for the first time. With this in mind, corporations need new and innovative ways to advertise and market their products to customers through mobile devices. Augmented reality technology has also experienced significant market growth and captured the intrigue of the public, particularly to those who adapt quickly to new and useful technologies.

With the need for unique advertising and marketing methods and the continued growth of mobile Internet usage and interest in augmented reality, an augmented reality-based advertising system would create additional product exposure, which in turn, would lead to increase sales and profits.

Accordingly, there is a need for an advertising system that utilizes augmented reality to overlay animated objects, such as animated images and/or videos on a product to capture the attention of a customer in a retail store, as described herein.

### BRIEF SUMMARY OF THE INVENTION

To meet the needs described above and others, the present disclosure provides an advertising system that utilizes augmented reality to overlay animated images and/or videos on a product and/or product label.

In one embodiment, the present disclosure provides an augmented reality-based advertising system. Potential customers for the advertising system include any merchant that sells good or services, such as electronic companies, food and beverage companies, and home product companies. Users of the advertising system include customers who purchase such goods and services.

The advertising system may include an object database and a mobile device with a camera. The mobile device may be a smartphone, tablet computer, smartwatch, personal digital assistants, handheld game console, or portable computers. Those of ordinary skill in the art and others will appreciate that the mobile device will generally include a processing unit (i.e., application processor) and memory. The memory generally comprises at least one of a random-access memory (“RAM”), a read only memory (“ROM”) and a permanent storage device, such as flash memory (e.g., flash RAM) or other non-volatile solid-state memory. Among other things, the memory stores an operating system and is capable of storing a variety of mobile applications.

The advertising system may also include a mobile application which a user may download and install on their mobile device. The object database may be stored locally in the memory of the mobile device or stored remotely on one or more database servers.

In operation, a user may launch the mobile application upon entering a retail store, such as a home goods store or grocery store. Upon launching the mobile application, the user may use the mobile device camera to scan the surrounding area for objects, such as products and/or product labels. During the scan, if a user momentarily pauses on an object, the advertising system first determines whether the scanned object is a product, product label, or another object. This determination may be made using object model or image recognition. For example, the advertising system may compare the image of the scanned object to images on the Internet to determine the object type. If the scanned object is identical or nearly identical to a product or product label found online, the advertising system will determine that the scanned object is a product or product label.

If the advertising system recognizes the scanned object as a product or product label, it will then compare the scanned object to images stored in the object database. If the scanned image is found in the object database, the object database next determines the correct augmented reality object to display to the user. The correct augmented reality object may be the object that relates to that particular product and/or product label. The augmented reality object may be an animated object such as video or animated graphic, including an animated Graphics Interchange Format (GIF), animated Tagged Image File Format (TIFF), or animated Portable Network Graphics (PNG).

The product and/or product label may also include a Quick Response (QR) code that a user can scan via their mobile device. Upon scanning the QR code, the advertising system determines what animated object to display.

Upon determining what augmented reality object to display, the mobile application scans the remaining surrounding area around the product and/or product label to simulate and build a three-dimensional environment. A video or animated graphic is then tracked and mapped to the product surface and/or an animated graphic label is tracked and mapped to the product label. The augmented reality object is then displayed to the user via the mobile application.

Additionally, the augmented reality object may be able to scale to the product and/or product label. As the user moves their mobile device about the product and/or product label, the animated object and/or animated label remains fixed to the targeting points, causing the animated object or label to stick in three-dimensional space. For example, if a user moves closer to or farther away from a product label, the animated label automatically scales to the size of the label being viewed on the mobile devices. If the user moves closer to the product label, the animated label will increase in size on the display screen and if a user moves away from the product label, the animated label will decrease in size on the display screen. The size and position of the animated label will also change if the user moves to the left or right of the product.

To create an augmented reality object to overlay on its product or product label, a corporate customer, such as a beverage company who wishes to create an animated label for its product packaging, may first scan the product label to build a three-dimensional matrix of object data around the product and/or product label. Next, the customer may establish object tracking points of the product label and identify product label positioning with anchor points within the label.

Then, the customer may create the animated product label by first scanning the high-resolution non-animated product label and then adding animation to the label, such as a bouncing ball. The customer may also add movement, audio, and/or video to the animated label. Next, the customer may map the previously identified tracking points to the animated product label and track the animation of the animated labels to the surface of the product label.

Next, the customer may store the three-dimensional model and tracking data in the object database, which can be stored locally on a user's mobile device or remotely on one or more database servers.

In an embodiment, the product and/or product label may vary in size. For example, the product could be product packaging, a bus, a semi-trailer truck with a display advertisement on the side of the vehicle, or a large display beside the highway or semi-trailer truck. The viewer can point their mobile device to the bus and read the QR Code which installs the mobile application on their mobile device. When the user opens the mobile application and points the camera towards the bus, semi-trailer truck, or highway advertisement, the mobile application will display the overlain augmented reality object to the user.

Although the previous embodiments describe the augment reality-based video system for use with advertising and marketing systems, the system is not limited to advertising and marketing. The system may be used in any situation where an animated object may be overlain on an object, such as in a museum or on a restaurant menu.

The augment reality-based advertising system overlays animated objects over a product and/or product label.

The augment reality-based advertising system can overlay an animated label onto a product label.

The augmented reality-based advertising system can overlay a video, with or without audio, over a product and/or product label.

The augmented reality-based advertising system can store animated objects in an object database.

The object database may be stored on a remote server.

The object database may be stored locally on a mobile device.

The object database may be stored both on a remote server and on a mobile device.

The augmented reality-based advertising system can scale the animated object during viewing as the user moves the mobile device about the product and/or product label.

The augmented reality-based advertising system can share data, such as viewing information, with a user's social media account(s).

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

FIG. 1 is a flow chart representing how the augmented reality-based advertising system may be used by a user to view an augmented reality object on a product and/or product label.

FIG. 2 is a flow chart representing how a corporation can use the augmented reality-based advertising system to develop an augmented reality object to display on a product and/or product label.

### DETAILED DESCRIPTION OF THE INVENTION

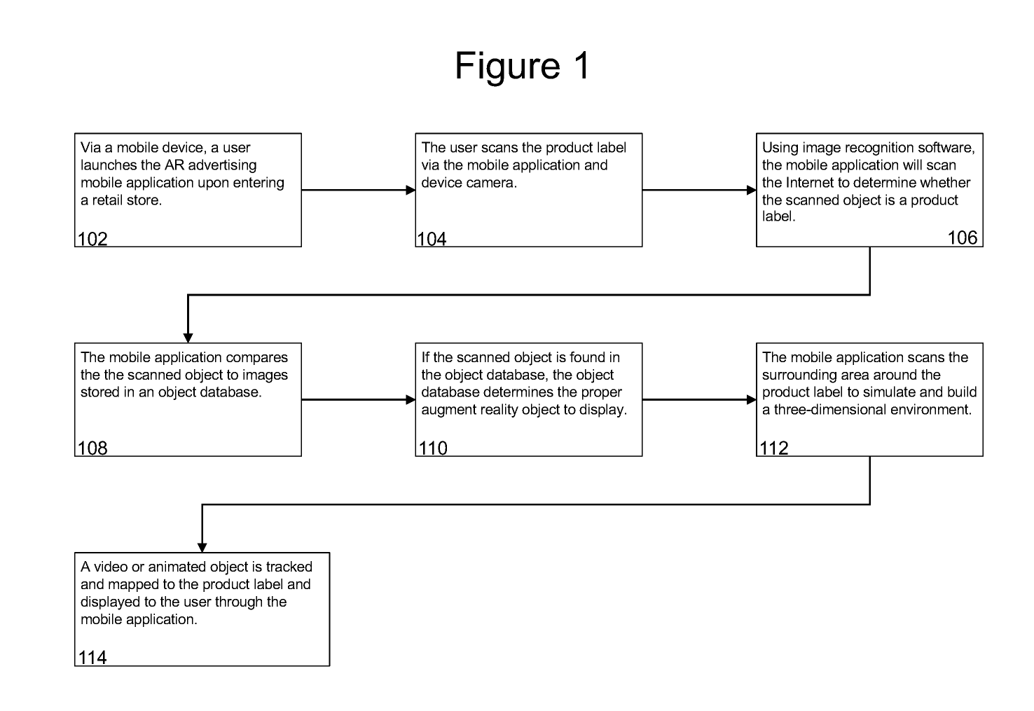

FIG. 1 illustrates how a user may use a mobile application included in the augmented reality-based advertising system to view an animated object overlain on a product and/or product label. As shown in FIG. 1, in step 102, a user may launch the augmented reality advertising mobile application when they enter a retail store, such as a grocery store. In step 104, the user, via the mobile application and mobile device camera, scans the product and/or product label. In step 106 the mobile application uses the image recognition software to scan the Internet to determine whether the scanned object is a product and/or product label. In step 108, the mobile application compares the scanned object to images stored in an object database. The object database may be stored locally on the user's mobile phone or stored remotely on one or more database servers.

In step 110, if the scanned object is found in the object database, the object database determines the proper augmented reality object to display. The augmented reality object may be an animated object such as video or animated graphic, including an animated Graphics Interchange Format (GIF), animated Tagged Image File Format (TIFF), or animated Portable Network Graphics (PNG).

Additionally, the augmented reality object may be able to scale to the product and/or product label. As the user moves their mobile device about the product and/or product label, the animated object and/or animated label remains fixed to the targeting points, causing the animated object or label to stick in three-dimensional space. For example, if the user moves closer to or farther away from a product label, the animated label automatically scales to the size of the label being viewed on the mobile devices. If the user moves closer to the product label, the animated label will increase in size on the display screen and if a user moves away from the product label, the animated label will decrease in size on the display screen. The size and position of the animated label will also change if the user moves to the left or right of the product.

In step 112, the mobile application, via the mobile device camera, scans the area around the product and/or product label to simulate and build a three-dimensional environment. Finally, in step 114, a video or animated object is tracked and mapped to the product label and displayed to the user through the mobile application.

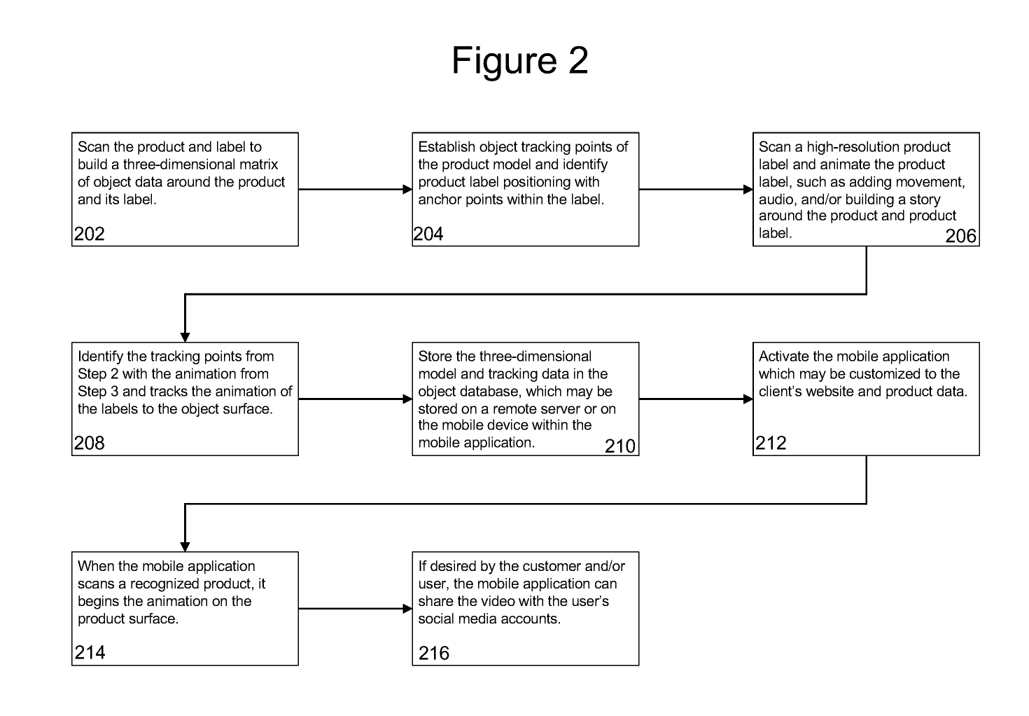

FIG. 2 illustrates one way in which a corporate customer, such as a brewery, winery, or distillery, can use the augmented reality-based advertising system to create an animated object, overlay the animated object onto a product and/or product label, and display the animated object to a user via a mobile application. In step 202, the corporate customer scans the product label to build a three-dimensional matrix of object data around the product and/or product label. Next, in step 204, the corporate customer may establish object tracking points of the product label and identify product label positioning with anchor points within the label. In step 206, the corporate customer creates the animated product and/or product label by scanning the high-resolution non-animated product and/or product label and then adding animation to the product and/or product label, such as a bouncing ball. The customer may also add movement, audio, and/or video to the animated label.

In step 208, the customer maps the previously identified tracking points to the animated product label and tracks the animation of the animated labels to the surface of the product label. In step 210, the customer stores the three-dimensional model and tracking data in the object database, which may be stored locally on a user's mobile device or remotely on one or more database servers.

Finally, in step 212, the customer activates the mobile application so that in step 214, when the mobile application scans the customer's product, it begins the animation programed into the augmented reality-based advertising system. Optionally, in step 216 the mobile application can share the animated video with the user's social media accounts.

It should be noted that various changes and modifications to the presently preferred embodiments described herein will be apparent to those skilled in the art. Such changes and modifications may be made without departing from the spirit and scope of the present invention and without diminishing its attendant advantages.

1. An augmented reality advertising system, comprising:
a mobile device with a camera;
a mobile application installed on the mobile device;
an object database;
wherein the mobile device, via the camera, scans an area for objects;
creating an object image and determining the object to be a product;
comparing the object image to an object database;
whereupon if the object image is found in the object database, determining what animated object to overlay on the product; and
overlaying the animated object on the product and displaying the animated object to a user via the display screen of the mobile device.

2. The system of claim 1 wherein the product is a bus.

3. The system of claim 1 wherein the product is a semi-trailer truck.

4. The system of claim 1 wherein the product is a highway advertisement.

5. The system of claim 1 wherein the object database is stored on a mobile device.

6. The system of claim 1 wherein the object database is stored on a remote server.

7. The system of claim 1 wherein the overlain animated object is actively scaled to the product.

8. The system of claim 1 wherein the animated object is overlain on the product's label.

9. The system of claim 1 wherein the animated object is a video.

10. The system of claim 1 wherein the animated object is an animated Graphics Interchange Format.

11. The system of claim 1 wherein the animated object is an animated Tagged Image File Format.

12. The system of claim 1 wherein the animated object is an animated Portable Network Graphic.

13. The system of claim 1 wherein the product includes a Quick Response (QR) code.

14. The system of claim 13 wherein a user can scan the QR code to display the overlain animated object.

15. A method of creating an augmented reality object to overlay on a product label, comprising:
scanning the product and product label to build a three-dimensional matrix of object data around the product;
establishing object tracking points of the product and identifying product label positioning with anchor points within the product label;
scanning a high-resolution product label and animating the product label by adding an animated object to the product label;
identifying the tracking points with the animated object and tracking the animation of the product labels to the product surface; and
storing the three-dimensional model and tracking data in an object database.
